(19) United States
(12) Patent Application Publication
(10) Pub. No.: US 2026/0007106 A1
(43) Pub. Date: Jan. 8, 2026

(54) SUNSHADE CANOPY FOR TRACTORS AND RIDING LAWN MOWERS

(71) Applicant: James Dax Elkins, Florence, AL (US)

(72) Inventor: James Dax Elkins, Florence, AL (US)

(21) Appl. No.: 19/180,894

(22) Filed: Apr. 16, 2025

Related U.S. Application Data
(60) Provisional application No. 63/668,394, filed on Jul. 8, 2024.

(51) Int. Cl. A01D 67/02; A01D 101/00

(52) U.S. Cl. CPC A01D 67/02; A01D 2101/00

(57) ABSTRACT

A sunshade apparatus for use with tractors and riding lawn mowers is disclosed. The apparatus includes an aluminum frame, a canvas canopy, and adjustable straps. The frame provides support for the canopy, which is adjustable in angle to optimize shade and visibility. The straps attach to the frame and mower, securing the sunshade in place. The sunshade is designed for ease of installation and use, providing reliable protection from the sun and other environmental elements.

### CROSS REFERENCE TO RELATED APPLICATION

This application claims the benefit of priority of U.S. provisional application No. 63/668,394, filed Jul. 8, 2024, the contents of which are herein incorporated by reference.

### BACKGROUND OF THE INVENTION

The use of lawn mowers and tractors has become an essential part of modern landscaping and gardening practices. However, one significant drawback to this process is the exposure to direct sunlight, which can lead to sunburn, heat exhaustion, and other heat-related issues for operators. This problem is particularly pronounced during peak mowing hours, when the majority of mowing work is typically done.

Currently available solutions to address this issue are limited and often cumbersome. Many existing devices require a roll-over protection system (ROPS) to mount to, which can be heavy, permanent, and inconvenient. Others may provide some shade, but at the cost of being bulky, awkward, or requiring permanent installation. These limitations make it difficult for operators to effectively manage sun exposure while mowing.

The current state of the art is marked by a lack of effective solutions that can provide reliable, easy-to-use, and adjustable shading for lawn mower operators. As a result, many operators are forced to choose between continuing their work despite the risks or finding alternative methods that may compromise the quality of their work.

The need exists for a sunshade that is specifically designed for use with tractors and riding lawn mowers, providing a reliable, easy-to-use, and adjustable solution for managing sun exposure. Such an invention would greatly improve the comfort and safety of operators while mowing and could also provide protection from other environmental elements like rain or snow.

The present invention relates to sunshades for use in connection with tractors and other riding lawn mowers. A great percentage of mowing is done during the day and in direct sunshine, leading to sun exposure and undesirable sun irritation, sun burn, and heat related issues for the operators.

Some conventional sunshades are designed to be installed on a roll over protection system, which is problematic because many conventional mowers do not have such devices. The present invention is a complete kit consisting of a frame, canopy, and hardware kit.

The sunshade of the present invention is easily installed and removed, and is self-supporting, light, easy to install and remove, and light.

### SUMMARY OF THE INVENTION

Broadly, the present invention is directed to a sunshade for use with tractors and riding lawn mowers, designed to provide protection from the sun and other environmental elements while operating these machines.

Current solutions for shading operators on tractors and riding lawn mowers are cumbersome, permanent, or heavy, requiring roll-over protection systems (ROPS) or being impractical for daily use. The present invention provides a reliable, easy-to-use, and adjustable sunshade that attaches to the tractor or mower using a hardware kit. It consists of an aluminum frame, canvas canopy, and nylon mounts that connect to corresponding receptacles on the machine's frame.

Some of the benefits achieved by the present invention include:
Reliable shading: Provides consistent and effective protection from the sun and other environmental elements.
Easy installation: Attaches quickly and easily using the hardware kit, without requiring complex setup or disassembly.
Adjustable: Allows for adjusting the angle of the canopy to optimize shade and visibility.
Practical: Designed for daily use on tractors and riding lawn mowers, with a lightweight and compact design that is easy to store when not in use.

Overall, the invention solves problems associated with providing reliable, easy-to-use, and adjustable shading solutions for operators on tractors and riding lawn mowers, while also offering practical benefits for everyday use.

These and other features, aspects and advantages of the present invention will become better understood with reference to the following drawings, description and claims.

### BRIEF DESCRIPTION OF THE DRAWINGS

FIG. 1 is a partial perspective view a sunshade installed on a mower in accordance with a preferred embodiment of the present invention;

FIG. 2 is a side view of the sunshade depicted in FIG. 1;

FIG. 3 is a detailed view taken along line 3-3 of FIG. 2; and

FIG. 4 is a detailed view taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The sunshade of the present invention provides a reliable, easy-to-use, and adjustable solution for operators seeking protection from the elements while performing their tasks. Its components work together seamlessly to provide optimal shading conditions, making it an essential tool for anyone working on tractors or riding lawn mowers.

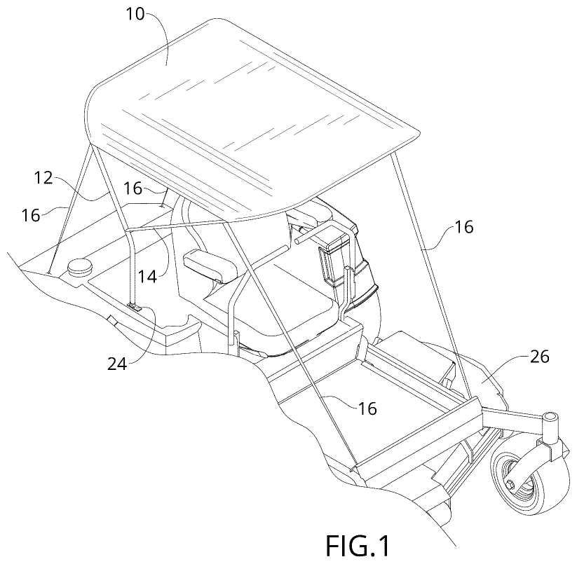

As described herein, and as seen by way of example in FIGS. 1-4, in a preferred embodiment the present invention comprises the following primary components:

Frame: The first primary component is an aluminum frame comprising first support bar (12) and second support bar (14). As seen by way of example in FIG. 1, support bar 12 is substantially U-shaped and attaches to each side of mower 26 at the end of each U via pivotal base 24. Support bar 12 extends from each pivotal base 24 substantially perpendicular from mower 26 and then bends toward the rear of mower 26. Second support bar 14 is also substantially U-shaped, and in a preferred embodiment attaches to first support bar 12 at a position above the bend on each leg.

Two adjustable straps (16) attach to the front of support bar 14 and extend to two strap loops 20 that attach to two strap anchors 22 that are positioned proximate the front of mower 26. Two other adjustable straps (16) attach to support bar 12 and extend to two strap loops 20 that attach to two strap anchors 22 that are attached proximate the rear of the mower 26.

Canopy: The second primary component is a canvas canopy 10 that is attached to support bar 12 at the rear of mower 26 and extends towards the front of mower 26 and is attached to support bar 14. Canopy 10 provides the shade.

Hardware: The third primary component is a hardware that makes installation easy. It includes screws and bolts for securing the sunshade to the mower, mounts, preferably nylon, for attaching the sunshade to the machine's frame, and stainless-steel strap anchors for connecting the sunshade to the machine's body.

### Operation:

Assemble the sunshade by attaching the canopy to the frame.
Attach the hardware kit components to the frame and machine, ensuring secure connections.
Adjust the canopy to achieve optimal shade and visibility.

### Advantages:

Reliable Shade: The canvas canopy provides consistent protection from the sun and other environmental elements.
Easy Installation: The hardware kit makes installation quick and easy, without requiring complex setup or disassembly.
Adjustable: The canopy can be adjusted to optimize shade and visibility, ensuring optimal operating conditions for the user.
Practical: The lightweight and compact design makes it easy to store when not in use.
Universal Fit: The sunshade is designed to fit a variety of tractor and riding lawn mower models, making it a versatile solution.

FIG. 1 illustrates the overall structure of the sunshade, showing the canopy (10), first support bar (12), and second support bar (14). The support bars are preferably aluminum tubing that provides support for the canopy. The canopy is preferably made of canvas material that provides shade for the user. The hardware kit includes screws, bolts, nylon mounts, and stainless-steel saddles that facilitate installation and attachment to the machine.

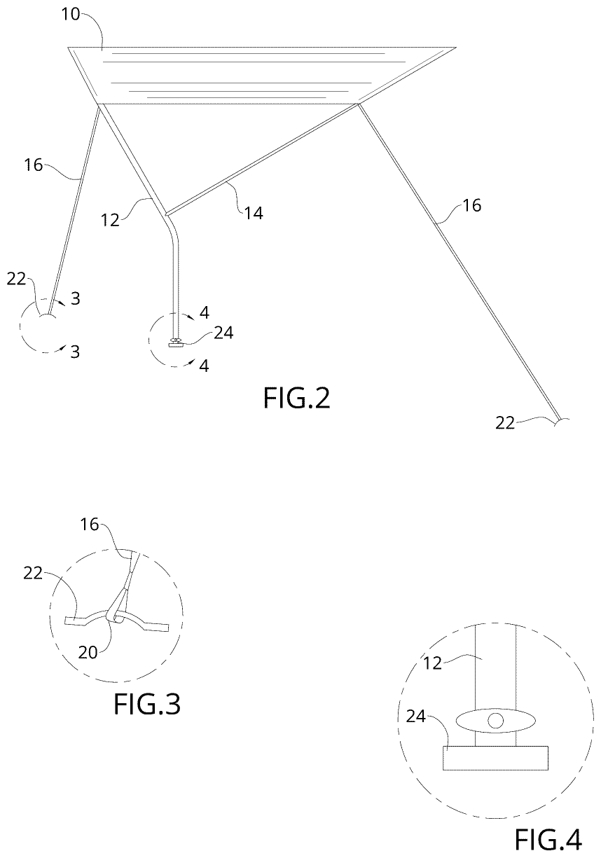

FIG. 2 depicts a detailed view of the support bars (12/14) adjustable straps (16) and canopy (10), showing the aluminum tubing bent in a specific manner to create the desired structure. FIG. 2 also shows the construction of the canopy and the way it is attached to the frame via stitching or sewing. The canopy provides protection from the sun, as well as other environmental elements such as rain, snow, sleet, and naturally occurring precipitation.

FIG. 3 illustrates a preferred method of attaching straps 16 to the mower 26, including the use of a loop 20 at the end of the strap 16 which connects to a strap anchor 22 which is mounted on mower 26. These components work together to facilitate easy installation and attachment of the sunshade to the machine.

FIG. 4 depicts a detailed view of how the support bar (12) is installed on mower 26 via a pivotable support base 24.

Each component plays a role in the overall functioning and utility of the sunshade. The combination of the frame, canopy, and hardware provides a reliable, easy-to-use, and adjustable solution for managing sun exposure while mowing.

It should be understood, of course, that the foregoing relates to exemplary embodiments of the invention and that modifications may be made without departing from the spirit and scope of the invention as set forth in the following claims.

What is claimed is:

1. An apparatus for providing shade and protection from the elements for an operator using a tractor or riding lawn mower, comprising:
an aluminum frame comprising a first support bar and a second support bar, wherein said first support bar has a substantially U-shaped configuration and attaches to each side of the mower at each end via a pivotal base;
a canvas canopy attached to the first support bar at the rear of the mower and extending towards the front of the mower and attached to said second support bar;
two adjustable straps attached to the second support bar and extending to strap loops that attach to strap anchors positioned proximate the front of the mower;
and two other adjustable straps attached to said first support bar and extending to strap loops that attach to strap anchors positioned proximate the rear of the mower.

2. The apparatus of claim 1, wherein said first support bar has a substantially perpendicular extension from the pivotal base to said second support bar.

3. The apparatus of claim 1, wherein said canopy is adjustable in angle with respect to said frame to optimize shade and visibility.

4. The apparatus of claim 1, wherein said strap anchors are positioned proximate the front and rear of the mower, respectively.

5. The apparatus of claim 1, wherein said frame is collapsible for easy storage and transportation.

6. A sunshade for use with tractors and riding lawn mowers, comprising:
a frame comprising aluminum tubing bent in a manner to fit the mower;
a canopy made of canvas material attached to said frame via stitching or sewing; and
a hardware kit including screws, bolts, nylon mounts, and stainless-steel saddles, wherein the canopy is attachable to the tractor or riding lawn mower by inserting the nylon mounts into corresponding receptacles on the mower's frame and securing with the screws and bolts.

7. The sunshade of claim 6, wherein said canopy is made of a waterproof and breathable canvas material.

8. The sunshade of claim 6, wherein said frame is designed to be collapsible, allowing for easy storage and transportation when not in use.

9. An apparatus for providing shade and protection from the elements for an operator using a tractor or riding lawn mower, comprising: an aluminum frame; a canopy attached to said frame; wherein said canopy is adjustable in angle with respect to said frame to optimize shade and visibility.
